(19) United States
(12) Patent Application Publication
(10) Pub. No.: US 2018/0201136 A1
(43) Pub. Date: Jul. 19, 2018

(54) ACTIVE MOTOR VEHICLE INSTRUMENT CLUSTER SYSTEM WITH INTEGRATED WEARABLE DEVICE

(71) Applicant: Continental Automotive GmbH, Hannover (DE)

(72) Inventors: Hua JIANG, Jiangning (CN); Jing YANG, Wuhu (CN); Jin XU, Nanjing (CN); Chao XIE, Jiangning (CN)

(21) Appl. No.: 15/918,805

(22) Filed: Mar. 12, 2018

Related U.S. Application Data
(63) Continuation of application No. PCT/EP2016/072648, filed on Sep. 23, 2016.

(30) Foreign Application Priority Data
Sep. 25, 2015 (CN) 201510623445.X

(51) Int. Cl. B60K 37/06; B60Q 9/00

(52) U.S. Cl. CPC B60K 37/06; G04G 21/04; B60K 2350/357; B60Q 9/00

(57) ABSTRACT

An active motor vehicle instrument cluster system with an integrated wearable device sends data of the wearable device to the motor vehicle instrument cluster.

### TECHNICAL FIELD

The present invention relates to the development of instrument cluster technology, in particular to an active motor vehicle instrument cluster system with an integrated wearable device.

### BACKGROUND ART

Existing motor vehicle instrument clusters serve as the main information display component in a motor vehicle, and have the principal function of presenting information relating to driving of the motor vehicle, e.g. speedometer, fuel gauge, water temperature gauge and fuel information. These items of information are mainly presented visually and aurally.

Thus, the ways in which information is presented by motor vehicle instrument clusters at the present time are not very varied, and there is a need to design a more effective way of presenting information, in order to present information that fits user's requirements better.

### SUMMARY OF THE INVENTION

The problem solved by the present invention is to provide an active motor vehicle instrument cluster system with an integrated wearable device, in order to provide an active information presentation method that fits user's requirements better.

To solve the abovementioned problem, the active motor vehicle instrument cluster system with an integrated wearable device of the present invention comprises:

a wearable device and a motor vehicle instrument cluster with a communication connection established wirelessly therebetween, wherein the wearable device, after being wirelessly connected to the motor vehicle instrument cluster, sends data of the wearable device to the motor vehicle instrument cluster, the data of the wearable device being obtained through collection by a sensor thereof, or obtained by a synchronous operation thereof, or obtained by user input; the motor vehicle instrument cluster performs targeted processing according to content of the data obtained, and feeds a processing result back to the wearable device, and the processing result is presented to the user by means of the wearable device.

Compared with the prior art, the solution above has the following advantages: once a wireless communication connection has been established between the wearable device and the motor vehicle instrument cluster, the wearable device acts as a “virtual identity” of the user, and provides an additional channel for information exchange between the user and the motor vehicle instrument cluster. An information transfer mechanism with mutual feedback is established between the wearable device and the motor vehicle instrument cluster through exchange and processing of multiple types of information. The wearable device obtains information about the user's current condition by means of sensors/synchronous data/user-inputted data, and once these items of information have been sent to the motor vehicle instrument cluster, the motor vehicle instrument cluster provides valid data to the user/presents that information which the user wishes to know most by means of targeted processing (e.g. by predicting the user's intentions with regard to operations during driving or data desired by the user during driving). In addition, a completely new information presentation experience is provided for the user.

### DESCRIPTION OF THE ACCOMPANYING DRAWINGS

FIG. 1 is a structural schematic diagram of an embodiment of the active motor vehicle instrument cluster system of the present invention;

FIG. 2 is a schematic diagram of a particular application example of the active motor vehicle instrument cluster system of the present invention.

### DETAILED DESCRIPTION

In the following description, many specific details are expounded in order to give those skilled in the art a more comprehensive understanding of the present invention. However, it will be obvious to those skilled in the art that the implementation of the present invention may lack some of these specific details. Moreover, it should be understood that the present invention is not limited to the specific embodiments presented. On the contrary, one may consider using any combination of the following features and key elements to implement the present invention, regardless of whether they relate to different embodiments. Therefore the following aspects, features, embodiments and advantages serve merely to explain, and should not be regarded as key elements or definitions of the claims, unless clearly stated in the claims.

As is well known, most existing wearable devices (e.g. smart watches, smart wristbands) have a health monitoring function, and in order to enable monitoring data to be displayed on mobile devices such as smart phones or tablet computers and to be controlled by such mobile devices, also correspondingly have a wireless connectivity function (e.g. by means of Bluetooth). The inventors of the present invention believe that a wearable device may be used as a node for the exchange of driver feature information and in-vehicle information; this node already has the functions of acquiring specific information, transmitting acquired specific information wirelessly, and obtaining information wirelessly. The active motor vehicle instrument cluster system of the present invention based on this structure comprises:

a wearable device and a motor vehicle instrument cluster with a communication connection established wirelessly therebetween, wherein the wearable device, after being wirelessly connected to the motor vehicle instrument cluster, sends data of the wearable device to the motor vehicle instrument cluster, the data of the wearable device being obtained through collection by a sensor thereof, or obtained by a synchronous operation thereof, or obtained by user input; the motor vehicle instrument cluster performs targeted processing according to content of the data obtained, and feeds a processing result back to the wearable device, and the processing result is presented to the user by means of the wearable device.

As a device which is closely associated with the user (driver or passenger), the wearable device acquires the abovementioned information which is more personalized for the user, through acquisition by various sensors carried on the wearable device itself, or through data synchrony with other electronic devices (e.g. mobile phone/tablet computer), or by obtaining user input via an input device carried on the wearable device itself, and supplies this information to the motor vehicle instrument cluster. The motor vehicle instrument cluster can, in part, use the wearable device as an “identity proxy” of the user in the usage environment of the motor vehicle. By means of this “identity proxy”, the motor vehicle instrument cluster can obtain more information focused on the user himself, e.g. health information such as the user's heartbeat, blood pressure and body weight, or itinerary information such as schedule and mail, or exercise information such as food/drink and calorie consumption, or environment information such as temperature, humidity, air pressure, weather, longitude/latitude and height above sea level. Moreover, information such as an intention with regard to an operation, which is manifested by the posture of a limb such as the user's arm, may also be captured and acquired by the wearable device. In addition, depending on whether the wearable device has hardware support, the user may also input information for the motor vehicle instrument cluster by means of touch, gesture or voice, etc.

With regard to motor vehicle instrument clusters in the prior art, these can generally only provide prompts or warnings of various types of information to the user in a manner which is set in advance before the motor vehicle instrument cluster exits the factory. With regard to certain items which can allow configuration changes (e.g. warning sound volume, routine information display method), these can only take effect in a manner configured in advance by the user; and before the next user configuration, prompts or warnings will be provided in the currently configured manner. In other words, motor vehicle instrument clusters in the prior art always passively display information or faults during operation of the motor vehicle, being unable to sense the user's intentions with regard to operations, or the user's demands. Therefore the implementation of the prior art on the basis of a motor vehicle instrument cluster is a passive information presentation method.

Comparatively speaking, since a wearable device is introduced into the motor vehicle instrument cluster system of the present invention to serve as an information exchange node, the motor vehicle instrument cluster can, through wireless communication with the wearable device, perform on-the-spot processing according to information items given as examples above, and feed a result of on-the-spot processing back to the wearable device. For example, the motor vehicle instrument cluster can temporarily adjust the threshold and manner of a speed warning on the basis of the current physical condition of the driver (e.g. sense the mood of the driver on the basis of heartbeat). As another example, when the motor vehicle instrument cluster issues a warning sound, a simple wave of the arm can be captured by the wearable device and sent to the motor vehicle instrument cluster, in order to reduce the warning volume or shut off the warning sound, with no need to wait for a preset warning duration to end, as was previously necessary. Alternatively, the driver's intended destination is acquired through navigation settings obtained by means of synchronous data and sent to the motor vehicle instrument cluster, to enable the motor vehicle instrument cluster to present a route plan (the processing of the route plan can be executed by another vehicle-mounted sub-system) for travelling to that destination to the user. This not only enriches the content of information presentation by the motor vehicle instrument cluster, but also increases the flexibility of user operations on the motor vehicle instrument cluster. Therefore the motor vehicle instrument cluster system of the present invention provides an active information presentation method (which may also be understood as being an information presentation method which adapts to the user).

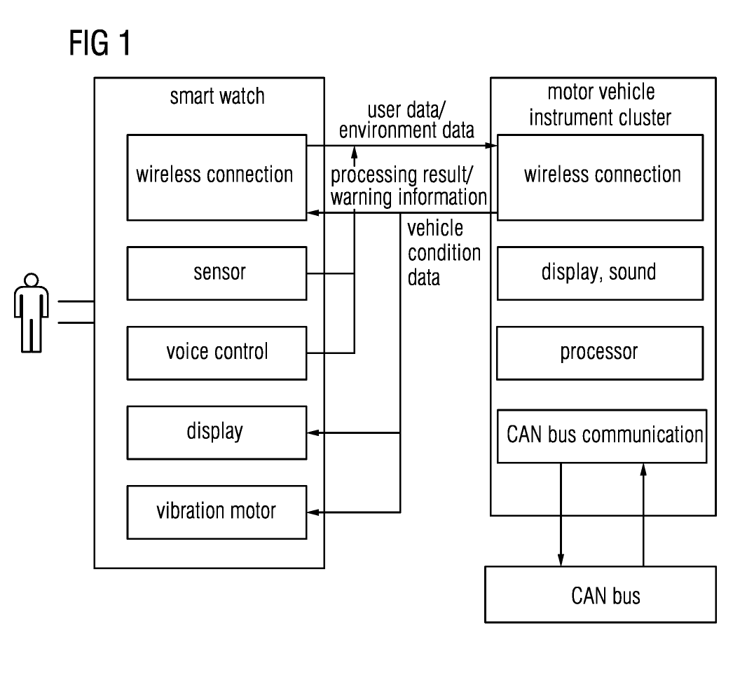

FIG. 1 provides an embodiment structural diagram based on the motor vehicle instrument cluster system of the present invention, with a smart watch as the wearable device as an example. However, it is clear that the wearable device of the present invention is not limited to a smart watch, but could also be a smart wristband or smart glasses. Referring to FIG. 1, the smart watch comprises: a communication module which realizes a wireless connection, various sensors (a 9-axis sensor, heartbeat sensor, light ray sensor, etc.), a voice control module, a display module and a vibration motor, etc. The motor vehicle instrument cluster comprises: a communication module which realizes a wireless connection, output modules for display and sound etc., a processor, and a communication module for CAN bus communication, etc.

The motor vehicle instrument cluster system operates in the following way:

Once a wireless connection has been established between the smart watch and the motor vehicle instrument cluster, the smart watch obtains information relating to the user by means of a sensor thereof or by means of the voice control module, and transmits these information items to the motor vehicle instrument cluster by means of the wireless communication module thereof;

furthermore, the motor vehicle instrument cluster performs targeted processing according to the particular information content transmitted by the smart watch, and sends feedback to the smart watch; for example, provides corresponding vehicle condition data feedback in response to a query operation (based on whole-vehicle information collected from the CAN bus, e.g. mileage, speed, engine rotation speed, water temperature, brake system information), or adjusts the content and manner of a warning or prompt thereof in response to a control operation, or based on user health information correspondingly adjusts or triggers a corresponding warning or prompt function, or sends warning information and/or vehicle condition data to the smart watch based on pre-settings.

The smart watch presents, by means of the display module thereof, the information content or warning fed back by the motor vehicle instrument cluster, e.g. by any one or more of text, picture and animation; or indicates the occurrence of a warning situation by means of the vibration motor. This may also be achieved by means of sound, if the smart watch has sound output. Of course, the abovementioned information content and warning may also be presented by means of the display module and sound module of the meter.

The operating process of the motor vehicle instrument cluster system of the present invention is explained further below by means of an application example relating to a fatigue driving warning.

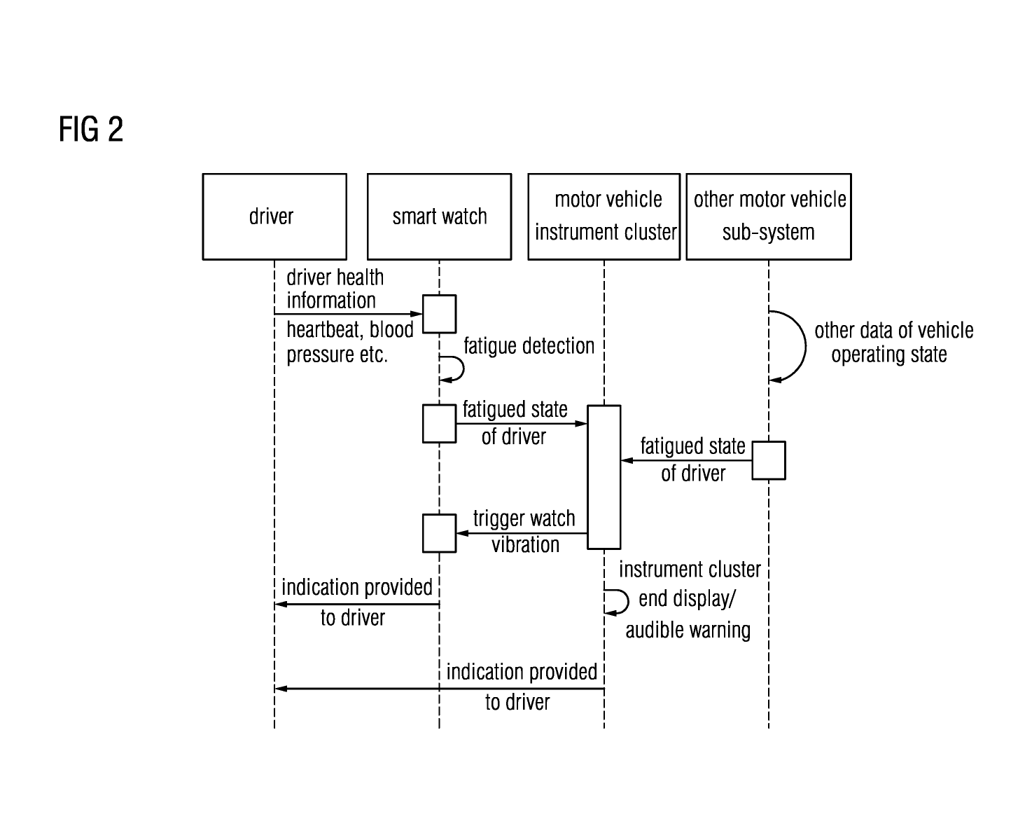

Referring to FIG. 2, the smart watch can, based on a health monitoring function thereof, obtain health information about the driver, such as heartbeat and blood pressure. Based on a health application which is built into the smart watch, the driver can be detected with regard to fatigue driving. If the information such as heartbeat and blood pressure obtained through monitoring indicate that the driver is in a fatigued state, the smart watch can send the information to the meter by wireless connection.

On the other hand, after obtaining information sent by the smart watch about the fatigued state of driver, the motor vehicle instrument cluster can provide assistance in determining whether the driver is really driving in a fatigued state by combining this information sent by the smart watch with operating state data of other motor vehicle sub-systems obtained from the CAN bus. For example, the fuel injection quantity (or the depth of depression of the accelerator pedal), the depth of depression of the brake pedal, or the rotation angle of the steering wheel may provide assistance in determining fatigue driving. Once it is determined that the driver is driving in a fatigued state, the motor vehicle instrument cluster can then feed the information back to the smart watch, to trigger vibration of the vibration motor in the smart watch in order to provide an indication to the driver. Alternatively, a warning may be correspondingly outputted by means of the display module thereof, or a warning may be correspondingly issued by means of the sound module thereof.

Of course, with regard to a fatigue driving warning, it can also be realized without assistance provided by combining with other vehicle operating state data. It depends entirely upon the requirements of the actual application.

Furthermore, different indication methods may be used, depending on the particular hardware entities participating in the determination of fatigue driving. For example, when the driver is determined to be in a fatigue driving state on the basis of the smart watch and the motor vehicle instrument cluster together, the vehicle may be taken out of the driver's control temporarily (e.g. by controlling the fuel injection quantity or the brakes), to ensure safe driving. If, on the other hand, the driver is determined to be in a fatigue driving state solely on the basis of the smart watch or the motor vehicle instrument cluster, then an indication may be provided in a relatively gentle manner (e.g. by sound, text, vibration, etc., as mentioned above), without subjecting the vehicle to control.

It is clear from the examples above that the motor vehicle instrument cluster obtains a greater amount of input information through the introduction of the smart watch. Based on this, more plentiful and user-oriented in-vehicle applications can be developed by combining various types of motor vehicle operating state data which the instrument cluster was originally capable of obtaining from the CAN bus. The results of processing these in-vehicle applications, once fed back to the smart watch, enable the user to obtain more assistance with driving.

In addition, a flexibly variable information prompting method can be set up, depending on the particular hardware entities participating in the current in-vehicle application. Thus, the introduction of a wearable device such as a smart watch, not only provides the motor vehicle instrument cluster with another data source, but also actually connects the user with the motor vehicle instrument cluster, so that many stages, such as information processing and information prompting, are all carried out in a manner geared toward the user. Thus, the active motor vehicle instrument cluster system of the present invention is highly capable of performing information processing in a manner which adapts to the user.

Although the present invention has been disclosed above by way of preferred embodiments, the present invention is by no means limited to this. Changes and amendments of various kinds, made by any person skilled in the art without departing from the spirit and scope of the present invention, shall be included in the scope of protection thereof. Therefore, the scope of protection of the present invention shall be the scope defined in the claims.

1. An active motor vehicle instrument cluster system with an integrated wearable device, the system comprising:
a wearable device and a motor vehicle instrument cluster with a communication connection established wirelessly therebetween,
wherein the wearable device, after being wirelessly connected to the motor vehicle instrument cluster, sends data of the wearable device to the motor vehicle instrument cluster, the data of the wearable device being obtained through collection by at least one of: a sensor, a synchronous operation thereof, and user input;
wherein the motor vehicle instrument cluster performs targeted processing according to content of the data obtained, and feeds a processing result back to the wearable device, and the processing result is presented to a user by means of the wearable device.

2. The active motor vehicle instrument cluster system of claim 1, wherein the motor vehicle instrument cluster, once wirelessly connected with the wearable device, sends warning information and vehicle condition data to the wearable device, and warning information and vehicle condition data is presented to the user by means of the wearable device.

3. The active motor vehicle instrument cluster system of claim 2, wherein the wearable device obtains user-inputted data in any one of the following ways: touch, gesture, voice, and limb posture capture.

4. The active motor vehicle instrument cluster system of claim 3, wherein the user-inputted data comprises at least one of the following: a control operation regarding the motor vehicle instrument cluster, user health information, user itinerary information, user exercise information, and user environment information.

5. The active motor vehicle instrument cluster system of claim 4, wherein the data obtained through collection by a sensor comprises at least one of: a control operation regarding the motor vehicle instrument cluster, user health information, and user environment information.

6. The active motor vehicle instrument cluster system of claim 5, wherein the user environment information comprises: temperature, humidity, air pressure, weather, longitude/latitude and height above sea level.

7. The active motor vehicle instrument cluster system of claim 6, wherein the data obtained by a synchronous operation comprises: user health information, user itinerary information, and user exercise information.

8. The active motor vehicle instrument cluster system of claim 7, wherein the wearable device presents the processing result as at least one of the following: a vibration, text, a picture, a sound, and animation.

9. The active motor vehicle instrument cluster system of claim 8, wherein the wearable device is a smart watch, or a smart wristband, or smart glasses.
